(19) United States
(12) Patent Application Publication
(10) Pub. No.: US 2017/0079474 A1
(43) Pub. Date: Mar. 23, 2017

(54) CUTTING GUIDE FOR RECTANGULAR BAKED GOODS

(71) Applicants: Jeffrey Stephen, Victoria (CA); Stephen Ferguson, Victoria (CA)

(72) Inventors: Jeffrey Stephen, Victoria (CA); Stephen Ferguson, Victoria (CA)

(21) Appl. No.: 14/857,884

(22) Filed: Sep. 18, 2015

(51) Int. Cl. A47J 37/01; B26B 29/06

(52) U.S. Cl. CPC A47J 37/01; A23L 1/0073; B26B 29/063; A23V 2002/00

(57) ABSTRACT

A cutting and scoring guide for directing cutting baked goods in a rectangular pan into rectangular pieces is provided, the cutting and scoring guide comprising: a top; an at least two opposing walls extending from the top and having a locking groove on an inner side for releasable mating with a lip of a rectangular baking sheet; a series of equally spaced long slots in the top, the series of long slots in parallel relation with the opposing walls, each long slot extending from a vicinity of a first end to a vicinity of an opposing second end of the top; and a plurality of short slots arranged in a series of lines to define a gap between each short slot in the top, the lines equalling no more than half the number of long slots and being normal to the long slots.

### RELATED APPLICATION

This application claims the benefit of U.S. Patent Application Ser. No. 62/052,416 filed on 18 Sep. 2014. The entire contents of the above-identified prior application is hereby incorporated by reference.

### FIELD

The present technology relates to a cutting guide for rectangular baked goods. More specifically, it is a cover that fits snugly over the baking pan and has slots that allow a user to draw a standard knife through the slots and either score or cut through the baked good, depending upon the direction, hence ensuring conformity in both the size and shape of the baked good.

### BACKGROUND

There are numerous templates that are used to cut round-shaped baked goods, such as pies and cakes. For example, U.S. Pat. No. 6,745,660 discloses a cake pan adapted for guidance in cutting a cake provides a pan bottom and a peripheral pan sidewall integral with the pan bottom and directed upwardly for terminating with a pan sidewall edge. The sidewall edge provides plural circular guide pins. A straightedge ruler has a straight edge of a length sufficient to span the cake pan from any one selected position on the sidewall edge to any further selected position on the sidewall edge. The guide pins are positioned such that with the straightedge ruler in contact with any selected pair of the guide pins, the straight edge is positioned for guiding straight-line cutting of the cake in a desired location on the cake corresponding to the straight edge. Another example is disclosed in U.S. Pat. No. 892,552 wherein a framework with bifurcating slots for using as a template for cutting pies and cakes is disclosed. The framework is suspended over the pie or cake with hooks that hook on to the pan. This is only useful if each cut piece is adjoining at least one edge of the baking tray. If a cut piece is needed from the center of the baking tray, this method is not suitable. Numerous others also disclose templates for cutting circular baked goods, some including an inverted cup with cut lines transecting at the centre. None of these are suitable for rectangular pans or rectangular baked goods.

The difficulties associated with designing a cutting guide for rectangular pans and rectangular baked goods can be understood by reviewing the prior art. For example, U.S. Pat. No. 3,727,508 discloses a knock-down rectangular frame has two opposite sides with straight edges which serve as knife guides. Adjustable distance pieces at the ends of the frame sides predetermine the heights of the straight edges.

U.S. Pat. No. 4,648,300 discloses a square frame surrounds and extends upwardly from a planar cutting surface to define a dough compartment. A plurality of vertical slots in each side wall extend from the top edge thereof down to the cutting surface to provide a guide for a cutting blade inserted therein. The slots are arranged in such a pattern that three, four, or six equal width slices may be formed in each direction depending on the slots selected for use. The cutter blade is accurately shaped along the bottom from end to end to ensure good contact with the cutting surface. An enlarged end portion at each end of the cutting blade prevents inadvertent dislodgement of the cutting blade during usage. A flour trough is provided on one side wall to facilitate the maintenance of a floured cutting blade during usage. This requires a special knife.

U.S. Pat. No. 6,009,786 discloses a method and apparatus for quickly and easily cutting straight and uniform dessert bars. The baker's cutting device consists of two parallel blocks connected perpendicularly by two parallel guide bars. The bottom of the front block is configured such that the block fits over one edge of the baking pan and the back edge of the block hangs over the edge of a table or counter top to hold the apparatus in place. The guide bars are in this manner suspended just over the top of a typical baking pan. Resting perpendicularly upon the guide bars is a sliding cutting bar. This cutting bar may be supplied with handles at each end. A plurality of cutting blades are attached to both the upper and lower sides of the cutting bar at various intervals. This again demonstrates that it is difficult to provide a useable template for rectangular products. Again, this requires a special knife.

U.S. Pat. No. 6,745,660 discloses a cake pan adapted for guidance in cutting a cake provides a pan bottom and a peripheral pan sidewall integral with the pan bottom and directed upwardly for terminating with a pan sidewall edge. The sidewall edge provides plural circular guide pins. A straightedge ruler has a straight edge of a length sufficient to span the cake pan from any one selected position on the sidewall edge to any further selected position on the sidewall edge. The guide pins are positioned such that with the straightedge ruler in contact with any selected pair of the guide pins, the straight edge is positioned for guiding straight-line cutting of the cake in a desired location on the cake corresponding to the straight edge. This requires that the user make decisions.

What is needed is an easy to use cutting guide for rectangular baked goods in rectangular pans. At present, bakeries are employing tape measures or other guides that need to be placed correctly and then retained in the correct position. It would be preferable that it requires no user input in terms of placing and retaining the guide or in terms of decision making. It would be still further preferable if a standard knife could be used. Still more preferably, the cutting guide could act as a cover for the baked good. An additional bonus might be that the cutting guide maximizes output of the bakery by allowing the user to cut increments more accurately than the common currently used guides. A still further benefit would be that the outside edges would be cast off. This way no cut product can be recognized as being cut from the edge of the tray or the middle. A further benefit to such accurate cut sizes and removal of perimeter waste would be to enable the user to better conform to product weight declaration on a nutritional information statement.

### SUMMARY

The present technology is an easy to use cutting guide for rectangular baked goods in rectangular pans. It requires no user input in terms of placing and retaining the guide or in terms of decision making. A standard knife can be used. The cutting guide can act as a cover for the baked good. An additional bonus is that the cutting guide maximizes output of the bakery by allowing the user to cut increments more accurately than the common currently used guides. The cutting guide is configured to exclude the cast off edge pieces influenced by the sloped edges of the baking tray. This way no cut product can be recognized as being cut from the edge of the tray or the middle. A benefit to such accurate cut sizes and removal of perimeter waste is to enable the user to better conform to product weight declaration on a nutritional information statement. An efficiency study shows that by using the guide to ensure accurate sizing and by adjusting bar sizes by a small amount such as ±10% a vast increase in production is possible. A specific example shows that if a user cuts 2″×2″ product from a standard half baking tray (approximately 12″×16″), 40 pieces of said size will be produced, however if the user is enabled to cut more accurately using this guide, product sizes of 1.81″×1.90″ will yield 54 pieces. This creates a 35% increase in productivity and direct profit.

In one embodiment, a combination for directing cutting baked goods into rectangular pieces is provided, the combination comprising: a rectangular baking sheet including a lip, a bottom and a curved side; and a rectangular cutting guide, the rectangular cutting guide including a top, an at least two opposing walls extending from an underside of the top, the at least two opposing walls sized to friction fit the lip of the baking sheet, a series of long slots in the top, the series of long slots in parallel relation, each long slot extending from a vicinity of a first end to a vicinity of an opposing second end of the top, a plurality of short slots arranged in a series of lines, an at least two short slots in each line, the lines in parallel relation and normal to the long slots, each short slot intersecting a single long slot to define a gap between each short slot in the top.

In the combination the long slots and the short slots may be aligned over the bottom of the baking sheet and are not over the curved side of the baking sheet.

In the combination the friction fit may be effected by the at least two opposing walls have a locking groove releasably mated with the lip of the baking sheet.

In the combination the rectangular baking sheet may be other than a square.

In the combination the series of long slots may be along a length of the cutting guide and the series of short slots are normal to the length of the cutting guide.

The combination may further comprise four short slots per line, the slots in a given line intersecting every second long slot

The combination may further comprise a handle extending from the top.

In the combination there may be four walls each abutting the underside of the top in a vicinity of a periphery of the top.

In the combination the walls and top may define four indents, each at a corner of the rectangular cutting guide.

In another embodiment, a cutting and scoring guide is provided for directing cutting baked goods in a rectangular pan into rectangular pieces, the cutting and scoring guide comprising: a top; an at least two opposing walls extending from the top and having a locking groove on an inner side for releasable mating with a lip of a rectangular baking sheet; a series of equally spaced long slots in the top, the series of long slots in parallel relation with the opposing walls, each long slot extending from a vicinity of a first end to a vicinity of an opposing second end of the top; and a plurality of short slots arranged in a series of lines to define a gap between each short slot in the top, the lines equalling no more than half the number of long slots and being normal to the long slots.

In the cutting and scoring guide each short slot may intersect a single long slot.

In the cutting and scoring guide the long slots and the short slots may be inset from a periphery of the top.

In the cutting and scoring guide the long slots may be longitudinal slots and the short slots are transverse slots.

In the cutting and scoring guide the opposing walls may be proximate the periphery of the top.

In the cutting and scoring guide each transverse slot may intersect the single longitudinal slot at a midpoint of the transverse slot.

The cutting and scoring guide may further comprise a handle extending from the top.

In the cutting and scoring guide there may be four walls in opposing pairs.

In the cutting and scoring guide the walls and top may define four indents, each at a corner of the cutting and scoring guide.

In the cutting and scoring guide each short transverse slot may join the longitudinal slot at a T-junction.

In yet another embodiment, a method of preparing a plurality of rectangular baked goods is provided, the method comprising: attaching the cutting and scoring guide of described above onto a rectangular baking sheet containing a baked good; cutting and scoring the baked good using the cutting and scoring guide as a template to provide a plurality of cuts and scores; removing the cutting and scoring guide from the baking sheet; and cutting the baked good along the plurality of scores, thereby providing a plurality of rectangular baked goods.

### FIGURES

FIG. 1A is an exploded perspective view of the cutting and scoring guide with a baking sheet. FIG. 1B is a partial perspective view of an alternative embodiment of FIG. 1A.

FIG. 1C is another partial perspective view of an alternative embodiment of FIG. 1A.

FIG. 2 is a partial side cross section view of the cutting and scoring guide with the baking sheet.

FIG. 3 is a plan view of two cutting patterns, the top one using the cutting and scoring guide of the present technology and the lower one using a tape measure.

FIG. 4 is a table showing various sizes of baked goods and the efficiency improvements realized using the cutting and scoring guide of the present technology.

### DESCRIPTION

Except as otherwise expressly provided, the following rules of interpretation apply to this specification (written description, claims and drawings): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, The terms “comprising,” “having,” “including,” and “containing” are to be construed as open ended terms (i.e., meaning “including, but not limited to,”) unless otherwise noted.

To the extent necessary to provide descriptive support, the subject matter and/or text of the appended claims is incorporated herein by reference in their entirety.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

### DEFINITIONS

Rectangle—in the context of the present technology, rectangle is any quadrilateral with four right angles, including a square.

### DETAILED DESCRIPTION

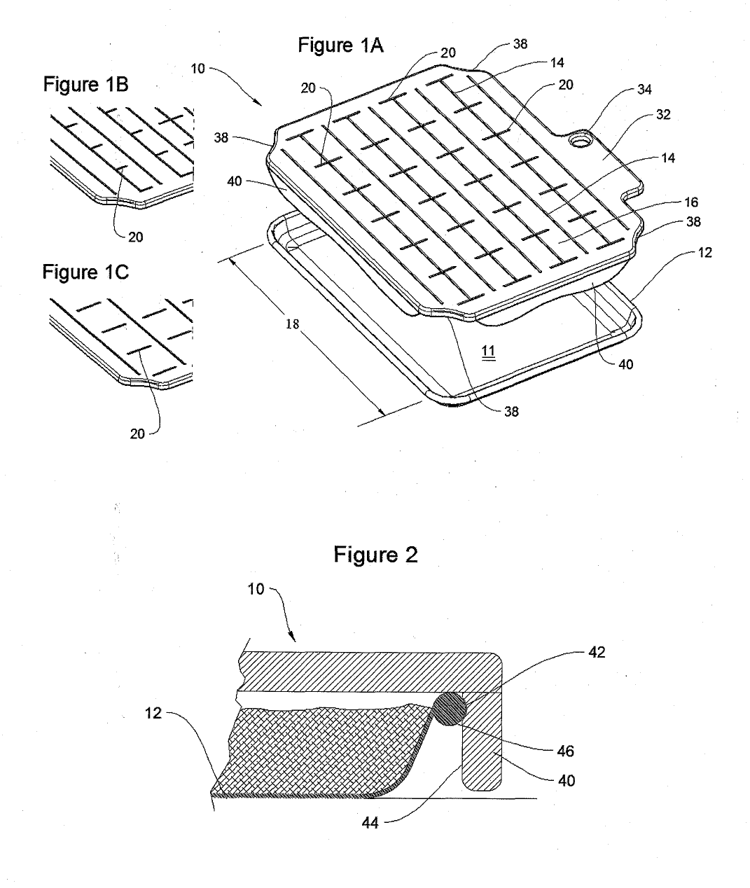

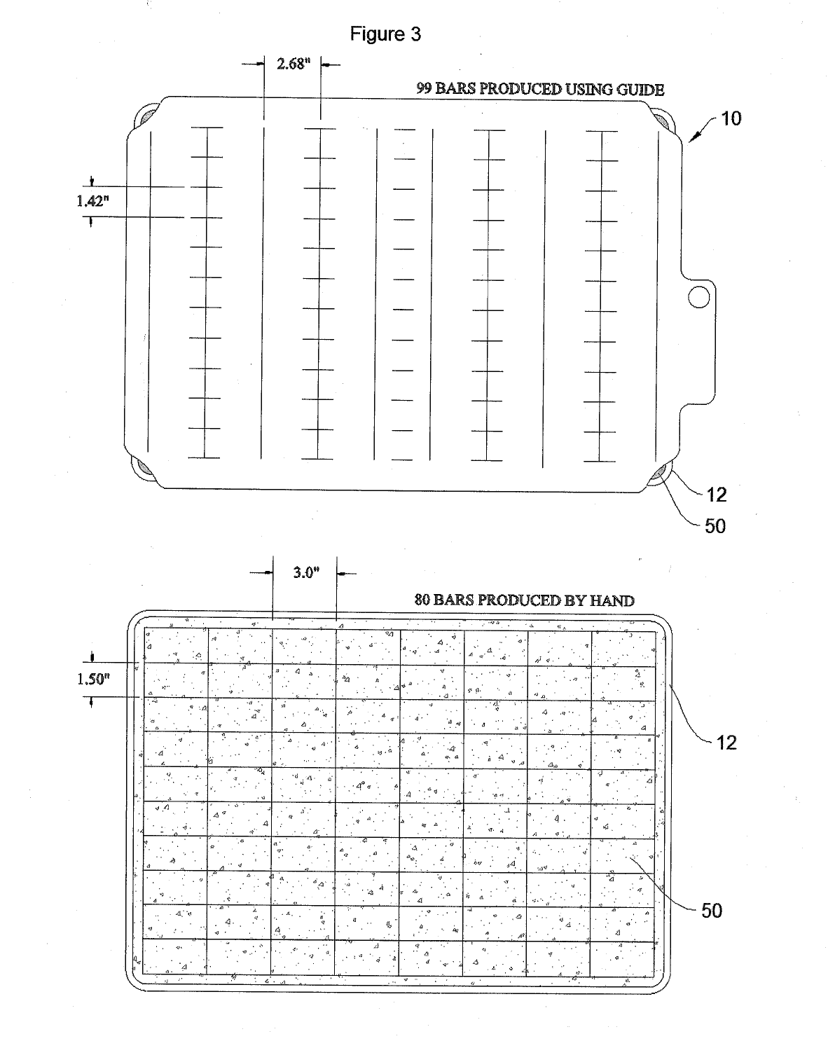

A cutting guide for rectangular baked goods, generally referred to as 10, is shown in FIG. 1A. The cutting guide 10 fits over a rectangular baking sheet 12. Longitudinal slots 14 in the top 16 extend the length 18 of the flat bottom 11 of the baking sheet 12 and transverse slots 20 are normal to the length 18, again avoiding the curved edge 13 of the baking sheet (see FIG. 2). Both slots 14, 20 extend through the top 16 and are wide enough to accept a standard knife blade. The transverse slots 20 join the ends 20 of every second longitudinal slot 14 and also join the longitudinal slots 14 at a desired spacing, which may be for example, but not limited to, every 1.8, 2, 2.8, 3 or 4 inches along the longitudinal slots 14. As shown in FIG. 1A, the transverse slots 20 extend equally either side of the longitudinal slots 14 into the top 16 by about 1 inch. In an alternative embodiment, as shown in FIG. 1B, the transverse slots 20 may extend from only one side of the longitudinal slots 14, providing T-junctions at the intersections of the slots 14, 20. In a further alternative embodiment, as shown in FIG. 1C, the transverse slots 20 may be separate from the longitudinal slots 14. In all three embodiments, the transverse slots 20 are such a length that a knife blade tip may be inserted through the transverse slot 20 to markably score the baked good below. This length leaves sufficient material in the cutting guide 10 to ensure that it does not warp or break, while permitting a knife blade to extend through the transverse slot 20 to score the baked good, hence the transverse slot 20 could be offset to one side or the other, or partially offset or any position in between, as long as the offset did not compromise the integrity of the cutting guide 10. A handle 32 with a thumb hole 34 extends out from the top 16 to allow a user to lift the cutting guide 10 off of the baking sheet 12. The top corners of the cutting guide 10 have indents 38 to further assist a user in lifting the cutting guide 10 off of the baking sheet 12. The thumb hole 34 on handle 32 can also be used to hang the cutting guide for easy storage. Walls 40 extend downward from the top 16, except at the indents 38.

A side view of the cutting guide 10 on the baking sheet 12 is shown in FIG. 2. A locking groove 42 on the inner surface 44 of the walls 40 releasably retains the curved edge (lip) 46 of the baking sheet 12. These function as mating pairs and ensure that the cutting guide 10 is firmly located on the baking sheet 12. This reduces the risk of the cutting guide 10 moving and the user then putting cuts in the baked goods in the wrong place. Such an error leads to wastage if the bars produced are not the minimum acceptable size or not the acceptable shape, and a reduction in efficiency if the bars are too large.

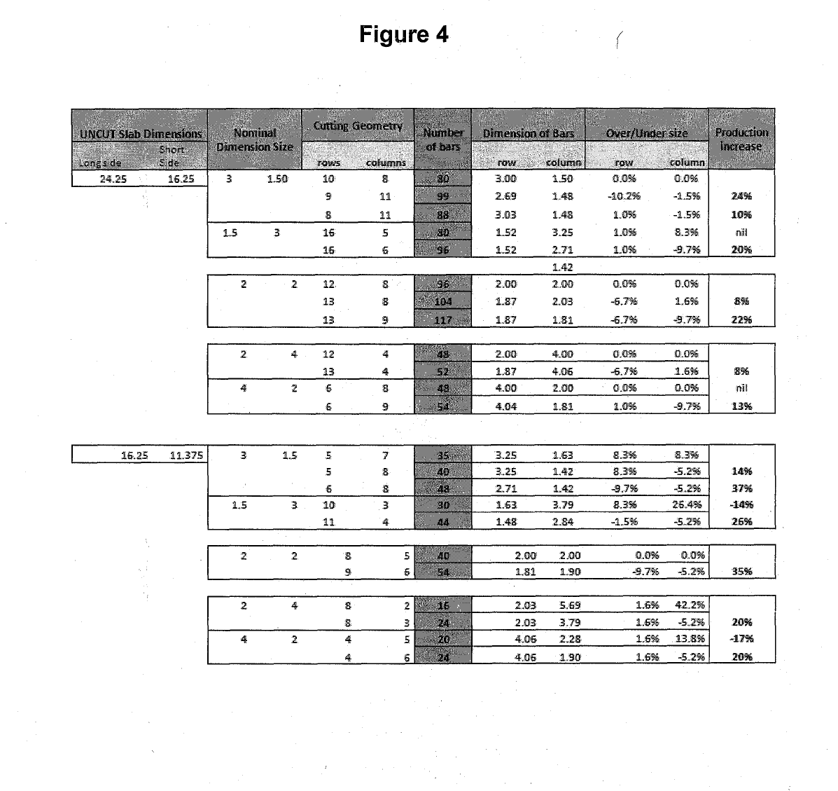

FIG. 3 shows various two combinations of sizes of rectangular baked goods 50 that can be obtained when cutting a baking sheet 12 of baked goods. As can be seen, if the user uses a tape measure, they can readily cut 8 columns of 3″ and 10 rows of 1.5″, yielding 80 bars. If, however, an increased yield of 9 columns and 11 rows producing 99 bars is desired, a higher degree of accuracy is needed to cut product to a final size of 2.69″×1.48″. Other non-limiting examples are shown, demonstrating clearly that the efficiency can be greatly improved when accurate cuts are made using the cutting guide 10.

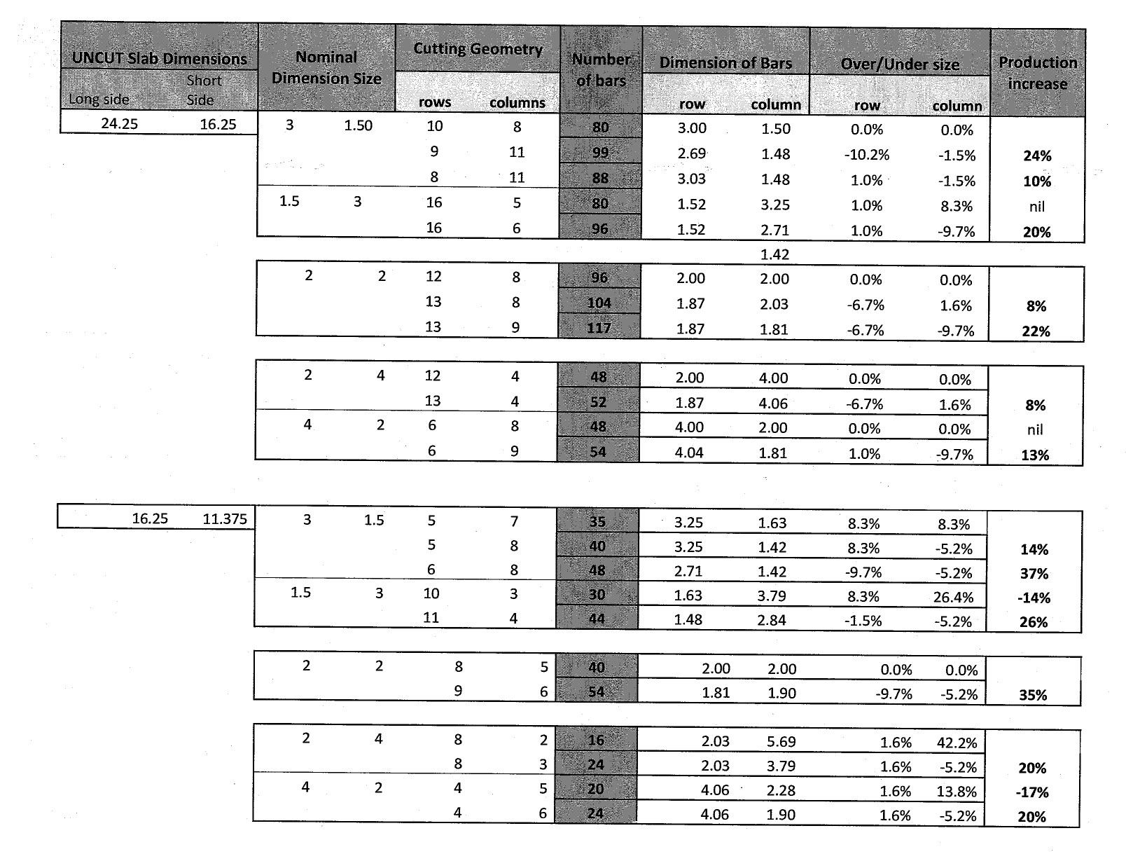

FIG. 4 shows various combinations of sizes of rectangular baked goods 50 that can be obtained when cutting a baking sheet 12 of baked goods. As can be seen, if the desired size of the bars is 2.69 inches by 1.48 inches, and the user cuts the bars at 3 inches by 1.5 inches (because they are using a tape measure, for example), then instead of producing 99 bars, only 80 bars are produced. Other non-limiting examples are shown, demonstrating clearly that the efficiency can be greatly improved when accurate cuts are made using the cutting guide 10.

Suitable materials for the cutting guide include Ultra high molecular Weight Polyethylene (UHMW), High Density Polyethylene (HDPE), Polypropylene (PP), or other food grade plastic. The depth of the top is preferably ⅜″, as this is the stock thickness of the material used. The depth of cutting and scoring guide is just under 1″.

In an alternative embodiment, the transverse slots 20 and the longitudinal slots 14 are transposed, such that the score lines run the length of the baking pan 12 and the cut lines run the width of the baking pan or sheet 12. In yet another embodiment, the walls 40 are positioned to friction fit on the lip 46.

In use, the cutting guide 10 is pressed into place on the rectangular baking sheet or pan 12. The user both scores the baked good transversely, and cuts the baked good longitudinally using a standard knife. The slots are configured such that they align only with the bottom of the baking sheet and avoid the curved side of the sheet. They then remove the cutting guide 10 from the rectangular baking sheet or pan 12, exposing the cut and scored baked good. Using the score line as a guide, they then cut transversely to produce a pan of rectangular baked goods. The cutting guides 10 are sized to fit a full range of rectangular baking sheets or baking pans 12. The baked goods can be, for example, but not limited to bars or squares such as granola bars or brownies, or, for example, rectangular cakes. The resulting baked goods are of a uniform size and shape, with no edge pieces.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize, or be able to ascertain using no more than routine experimentation, many equivalents to the specific example embodiments specifically described herein. Such equivalents are intended to be encompassed in the scope of the claims, if appended hereto or subsequently filed.

1. A combination for directing cutting baked goods into rectangular pieces, the combination comprising: a rectangular baking sheet including a lip, a bottom and a curved side; and a rectangular cutting guide, the rectangular cutting guide including a top, an at least two opposing walls extending from an underside of the top, the at least two opposing walls sized to friction fit the lip of the baking sheet, a series of long slots in the top, the series of long slots in parallel relation, each long slot extending from a vicinity of a first end to a vicinity of an opposing second end of the top, a plurality of short slots arranged in a series of lines, an at least two short slots in each line, the lines in parallel relation and normal to the long slots, each short slot intersecting a single long slot to define a gap between each short slot in the top.

2. The combination of claim 1, wherein the long slots and the short slots are aligned over the bottom of the baking sheet and are not over the curved side of the baking sheet.

3. The combination of claim 2, wherein the friction fit is effected by the at least two opposing walls have a locking groove releasably mated with the lip of the baking sheet.

4. The combination of claim 3, wherein the rectangular baking sheet is other than a square.

5. The combination of claim 4, wherein the series of long slots are along a length of the cutting guide and the series of short slots are normal to the length of the cutting guide.

6. The combination of claim 5, further comprising four short slots per line, the slots in a given line intersecting every second long slot

7. The combination of claim 6, further comprising a handle extending from the top.

8. The combination of claim 7, wherein there are four walls each abutting the underside of the top in a vicinity of a periphery of the top.

9. The combination of claim 8, wherein the walls and top define four indents, each at a corner of the rectangular cutting guide.

10. A cutting and scoring guide for directing cutting baked goods in a rectangular pan into rectangular pieces, the cutting and scoring guide comprising: a top; an at least two opposing walls extending from the top and having a locking groove on an inner side for releasable mating with a lip of a rectangular baking sheet; a series of equally spaced long slots in the top, the series of long slots in parallel relation with the opposing walls, each long slot extending from a vicinity of a first end to a vicinity of an opposing second end of the top; and a plurality of short slots arranged in a series of lines to define a gap between each short slot in the top, the lines equalling no more than half the number of long slots and being normal to the long slots.

11. The cutting and scoring guide of claim 10, wherein each short slot intersects a single long slot.

12. The cutting and scoring guide of claim 11, wherein the long slots and the short slots are inset from a periphery of the top.

13. The cutting and scoring guide of claim 12, wherein the long slots are longitudinal slots and the short slots are transverse slots.

14. The cutting and scoring guide of claim 13, wherein the opposing walls are proximate the periphery of the top.

15. The cutting and scoring guide of claim 14 wherein each transverse slot intersects the single longitudinal slot at a midpoint of the transverse slot.

16. The cutting and scoring guide of claim 15, further comprising a handle extending from the top.

17. The cutting and scoring guide of claim 16, wherein there are four walls in opposing pairs.

18. The cutting and scoring guide of claim 17, wherein the walls and top define four indents, each at a corner of the cutting and scoring guide.

19. The cutting and scoring guide of claim 18, wherein each short transverse slot joins the longitudinal slot at a T-junction.

20. A method of preparing a plurality of rectangular baked goods, the method comprising: attaching the cutting and scoring guide of claim 10 onto a rectangular baking sheet containing a baked good; cutting and scoring the baked good using the cutting and scoring guide as a template to provide a plurality of cuts and scores; removing the cutting and scoring guide from the baking sheet; and cutting the baked good along the plurality of scores, thereby providing a plurality of rectangular baked goods.
